(19) United States
(12) Patent Application Publication
(10) Pub. No.: US 2013/0346027 A1
(43) Pub. Date: Dec. 26, 2013

(54) CASH DRAWER HAVING A BLUETOOTH INTERFACE

(71) Applicants: Paul St. George, Vadnais Heights, MN (US); Patrick Vue, Champlin, MN (US)

(72) Inventors: Paul St. George, Vadnais Heights, MN (US); Patrick Vue, Champlin, MN (US)

(21) Appl. No.: 14/010,126

(22) Filed: Aug. 26, 2013

Related U.S. Application Data
(63) Continuation-in-part of application No. 12/983,493, filed on Jan. 3, 2011.
(60) Provisional application No. 61/293,378, filed on Jan. 8, 2010.

(51) Int. Cl. G01D 9/00

(52) U.S. Cl. CPC G01D 9/00
USPC 702/187

(57) ABSTRACT

Cash drawers having a Bluetooth interface and a processing unit are disclosed. The processing unit detects cash drawer events and transmits an indication of the cash drawer events across the Bluetooth interface. The cash drawer optionally includes a storage component that stores the indication of the cash drawer events. The cash drawer may receive electrical power from an external supply.

### REFERENCE TO RELATED APPLICATION(S)

The present application is a continuation-in-part of application Ser. No. 12/983,493 filed on Jan. 3, 2011, which is based on and claims the benefit of provisional application Ser. No. 61/293,378 filed on Jan. 8, 2010; the content of these applications are hereby incorporated by reference in their entirety.

### BACKGROUND

Cash drawers are commonly employed at point-of-sale (POS) locations such as retail businesses. Cash drawers are used to securely store currency, credit card receipts, and the like until a financial transaction occurs, at which time the drawer is opened to access the contents. Normally such cash drawers are spring-loaded and are opened by energizing a solenoid to release a latch. In a common mode of operation, opening of a cash drawer is initiated from a POS terminal.

### SUMMARY

An aspect of the disclosure relates to a cash drawer having a Bluetooth interface and a processing unit. The processing unit detects cash drawer events and transmits an indication of the cash drawer events across the Bluetooth interface. The cash drawer optionally includes a storage component that stores the indication of the cash drawer events. The cash drawer may receive electrical power from an external supply.

These and various other features and advantages that characterize the claimed embodiments will become apparent upon reading the following detailed description and upon reviewing the associated drawings.

### BRIEF DESCRIPTION OF THE DRAWINGS

FIG. 1 is a diagram of an operating environment in which cash drawers having network interfaces may be incorporated in.

FIG. 2 is a schematic electrical diagram of a cash drawer having a network interface.

FIG. 3 is an illustration of an event log stored by a cash drawer.

FIG. 4 is a user interface displaying cash drawer statistics.

FIG. 5 is a flow chart of a method for troubleshooting cash drawer issues and/or for cash drawer asset management.

FIG. 6 is a diagram of one implementation of a cash drawer network.

FIG. 7 is a a perspective view of a cash drawer.

FIG. 8 is a top down view of the cash drawer of FIG. 7 with the top of the housing and the till having been removed.

FIG. 9 is a flow chart of a method of communicating with a cash drawer over a network.

FIG. 10 is a schematic diagram illustrating a system having a wireless cash drawer communication interface, under one embodiment.

### DETAILED DESCRIPTION

At least some embodiments of the present disclosure include cash drawers that are connected to a network (e.g. an Ethernet network) through a network interface. Each cash drawer is a separate device or node on the network, instead of simply being a peripheral to another device such as a POS terminal. A network connected cash drawer may provide several advantages. For instance, a network connected cash drawer may be operated by multiple devices (e.g. multiple POS terminals) connected to the network. Also for instance, asset management may be improved by tracking and remotely reporting cash drawer usage statistics. These and other possible advantages are discussed in greater detail below.

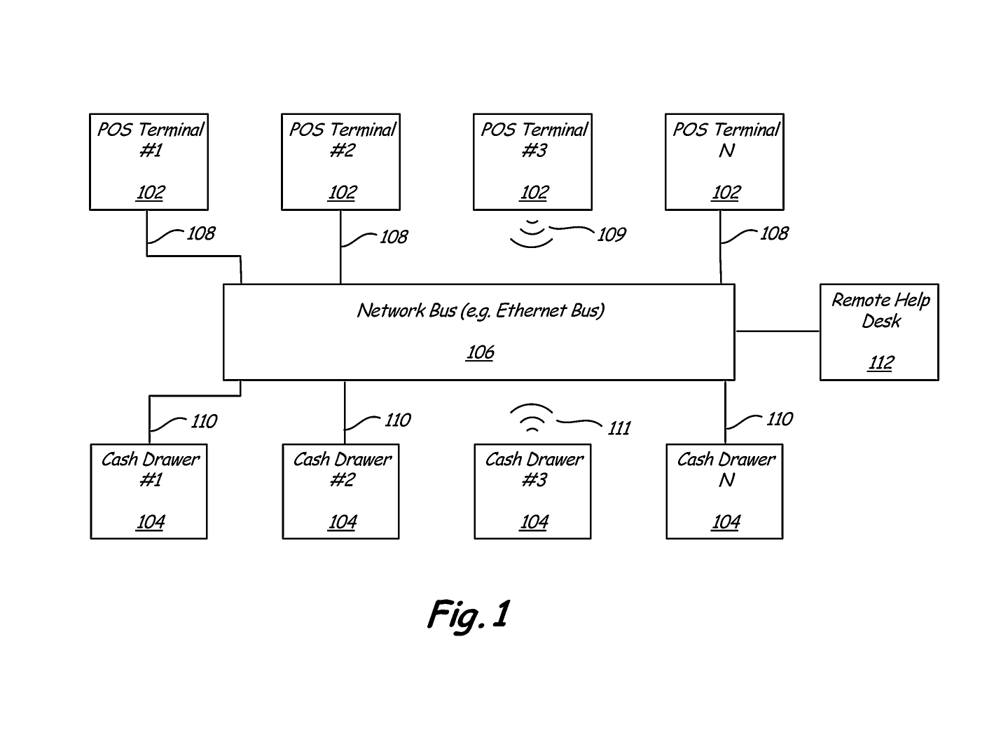

FIG. 1 shows one illustrative operating environment in which cash drawers having a network interface may be incorporated in. Embodiments are not however limited to any particular environment and may be practiced in environments different than that shown in FIG.

FIG. 1 shows multiple POS terminals 102 and multiple cash drawers 104 connected to a network through a network bus 106. Any number of POS terminals 102 and any number of cash drawers 104 may be connected to a network bus 106. Network bus 106 allows for devices connected to it to be able to detect each other and to communicate with one another. For instance, devices connected to bus 106 illustratively send messages in the form of a data packet called a frame. Each frame optionally includes a source device address (e.g. a Media Access Control “MAC” identifier), a destination device address (e.g. a MAC identifier), the data to be transmitted (e.g. the payload data), and a cyclic redundancy check (e.g. a 32-bit cyclic redundancy check) which is used to detect any corruption of data during transit.

Each POS terminal 102 illustratively includes a user interface that enables a user to control one or more cash drawers 104. POS terminals 102 are not limited to any particular kind of or configuration of device. Some examples of devices that may be used for POS terminals 102 include thick or thin servers, personal computers, netbooks, cell phones/smart phones, personal digital assistants, tablet computers (e.g. an Apple iPad), etc.

POS terminals 102 are able to communicate commands to cash drawers 104 and receive information from cash drawers 104 through bus 106. Some examples of commands, for illustration purposes only and not by limitation, include an open drawer command, a prompt to have the cash drawer return its open/closed status command, a retrieve and clear event logs command, an assign user specific information into a cash drawer asset event log command, a controlled user access command to set a real time clock for date and time stamping of events, and a cash drawer audible alerts enable/disable command that optionally enables or disables an audible alert. For instance, an audible alert may be set to follow a cash drawer being opened by a POS terminal 102, a cash drawer being opened with a key, or a cash drawer not being closed after a specified time interval. Any other commands may also optionally be included within embodiments.

As is illustrated in FIG. 1, POS terminals 102 are able to connect to the network bus 106 through either a wired connection 108 or alternatively through a wireless connection 109. Embodiments are not limited to any particular connection scheme. Some examples of wireless connection 109 include connections using Wi-Fi (e.g. IEEE 802.11) or Bluetooth (e.g. 2402-2480 MHz) technologies.

In an embodiment, each POS terminal 102 is able to control and exchange information with each cash drawer 104. For instance, a POS terminal 102 is illustratively able to pick one of the several cash drawers 104 to communicate with (e.g. open). However, in another embodiment, POS terminals 102 may be restricted to which cash drawers 104 they have access to for security or other reasons. Embodiments are not limited to any particular configuration and may have other configurations as well.

Similar to POS terminals 102, cash drawers 104 may either have a wired connection 110 or alternatively have a wireless (e.g. Wi-Fi or Bluetooth) connection 111. Additionally, it should be noted that cash drawers 104 may be powered by an external power source (e.g. a connection to a wall outlet) or may be powered over the same line 110 that connects the cash drawer 104 to the network bus 106. For instance, cash drawer connection 110 may use Power over the Ethernet (PoE) technology such that the cash drawer receives power over the same line (e.g. a category 5 line) that transmits data.

FIG. 1 shows that an optional remote help desk 112 is also connected to network bus 106. Remote help desk 112 may be implemented as a server, personal computer, or any other computing device. Additionally, remote help desk 112 may connect to bus 106 through an internet connection (i.e. remote help desk 112 may be remotely connected to the network). Help desk 112 is illustratively able to communicate with all of the devices on the network bus 106 (i.e. POS terminals 102 and cash drawers 104). Help desk 112 may be used to troubleshoot issues with one or more devices on the bus 106, or may used for other functions such as asset management. For instance, help desk 112 in an embodiment is able to view statistics for each of the cash drawers 104 and management decisions (e.g. the decision to swap the physical locations of two cash drawers 104) can be made based on the statistics.

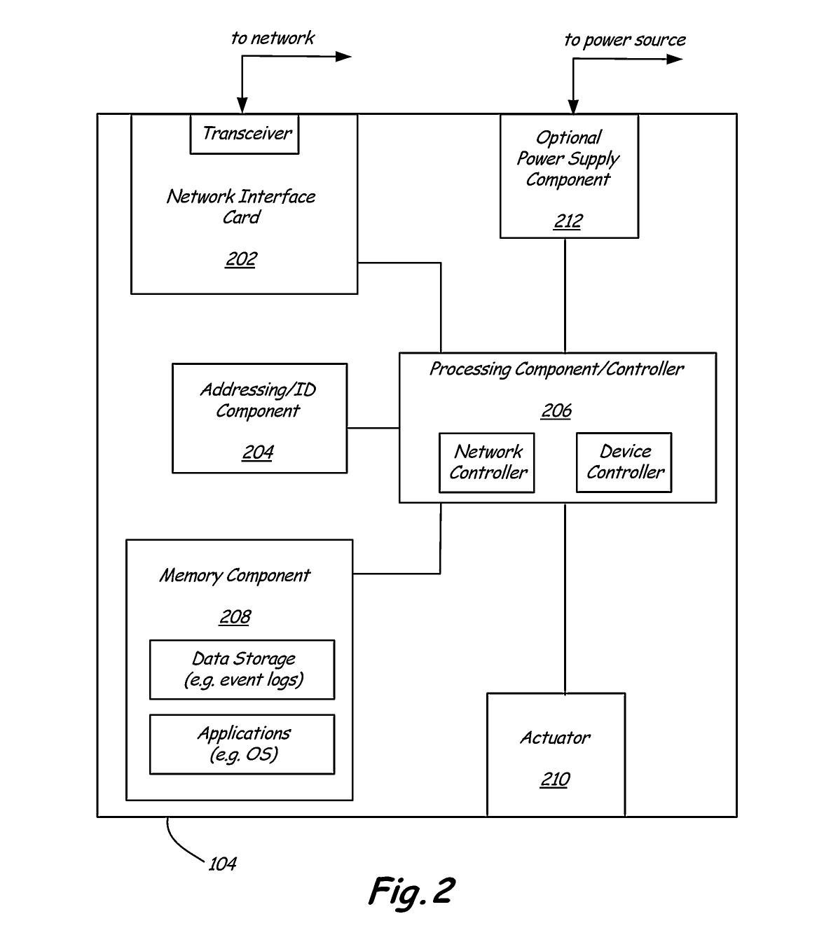

FIG. 2 is a schematic electrical diagram of a cash drawer 104. Cash drawer 104 includes a network interface card 202, an addressing component 204, a processing component/controller 206, a memory component 208, an actuator 210, and a power supply 212. Network interface card 202 includes a transceiver that is able to transmit data to and receive data from the network. As was previously mentioned, the transceiver may optionally use either a wired connection or use wireless technology to connect to the network.

Addressing/identification component 204 is used in identifying the cash drawer 104 to the network. In one embodiment, addressing component 204 includes a unique serial number that is used to uniquely identify the particular cash drawer from amongst any other device. The unique serial number may be used as part of a Media Access Control (MAC) address scheme utilized by the network. Embodiments of the present disclosure are not however limited to any particular addressing scheme and illustratively include any addressing scheme. Other examples of addressing schemes that may be used include those that use Dynamic Host Configuration Protocol (DHCP) IP address assignment and those that use static IP address assignment/re-assignment.

Processing component/controller 206 illustratively controls the operations of cash drawer 104. In one embodiment, controller 206 includes a network controller portion and a device controller portion. The network controller portion enables the cash drawer to be detected on the network and allows for communications to be transmitted between devices and applications on the network. For instance, the network controller portion receives commands for cash drawer operations and also sends cash drawer information (e.g. log data) to a requesting device and/or application.

The device controller portion stores cash drawer device information and event log entries. The log entries are for example stored in a non-volatile memory to ensure that data is not lost when the drawer is disconnected from the network, powered down, or moved to another network. The device controller portion also monitors an actuator 210 (e.g. a micro-switch) inside the cash drawer that monitors the open/closed status and that provides an electrical pulse that energizes a solenoid to release a latch that allows the cash drawer to be opened. Furthermore, the device controller portion may support auxiliary hardware that provides feedback of cash drawer operations or status such as, but not limited to, lights (e.g. LEDs) that report status and/or audible alerts that inform users or managers nearby if the cash drawer has been opened.

Memory component 208 includes any type or combination of memory that may be useful in operation of cash drawer 104. In an embodiment, memory component 208 may include volatile and non-volatile memory. Information that should be retained despite a power loss is illustratively stored to non-volatile memory such as, but not limited to, a magnetic hard disk drive, flash memory, or battery backed DRAM. Some information that may be stored to non-volatile memory includes event log information and applications (e.g. an operating system or POS application).

Optional power supply component 212 facilitates any needed power conditioning, transformation, etc. that may be needed to power the other components of the cash drawer 104. For instance, in a situation in which cash drawer 104 receives power from an external power source (e.g. a 110 volt alternating current wall outlet), power supply component 212 converts the alternating current into one or more direct currents that are fed to the different components of the cash drawer. Similarly, in a situation in which cash drawer 104 receives power from Power over the Ethernet, power supply unit 212 performs any needed conversions/transformations of power so that the cash drawer components receive their electrical requirements.

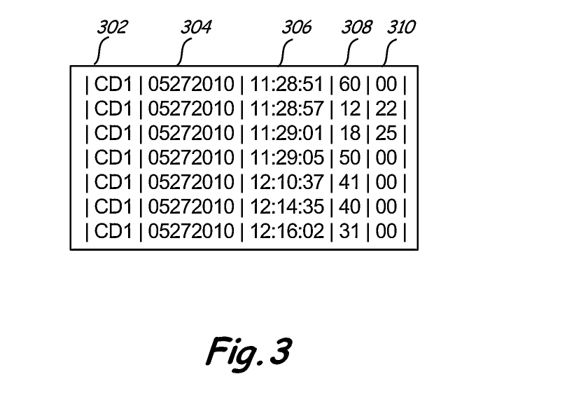

FIG. 3 is an illustration of one embodiment of an event log that is generated by a cash drawer and is stored to its memory (e.g. non-volatile memory). Any information that is useful for maintaining, troubleshooting, or managing cash drawers may be stored in an event log. In the specific example shown in FIG. 3, the event log includes a cash drawer identifier 302 that uniquely identifies a cash drawer, a date indicator 304, a time indicator 306, an event identifier 308, and an event status identifier 310. Event identifier is illustratively a code that corresponds to a cash drawer event. Some cash drawer events that may be identified include a cash drawer open by a POS command, a cash drawer open by a manual actuation (e.g. by a key), a cash drawer close, a length of time a cash drawer remains open, a connection or disconnection between a cash drawer and a network, a power supply (e.g. DC adaptor) power up or power down, audible alert activations, etc. Event status identifier 310 may identify a status of an event such as successful, unsuccessful, unknown, or any other status that may be required or useful.

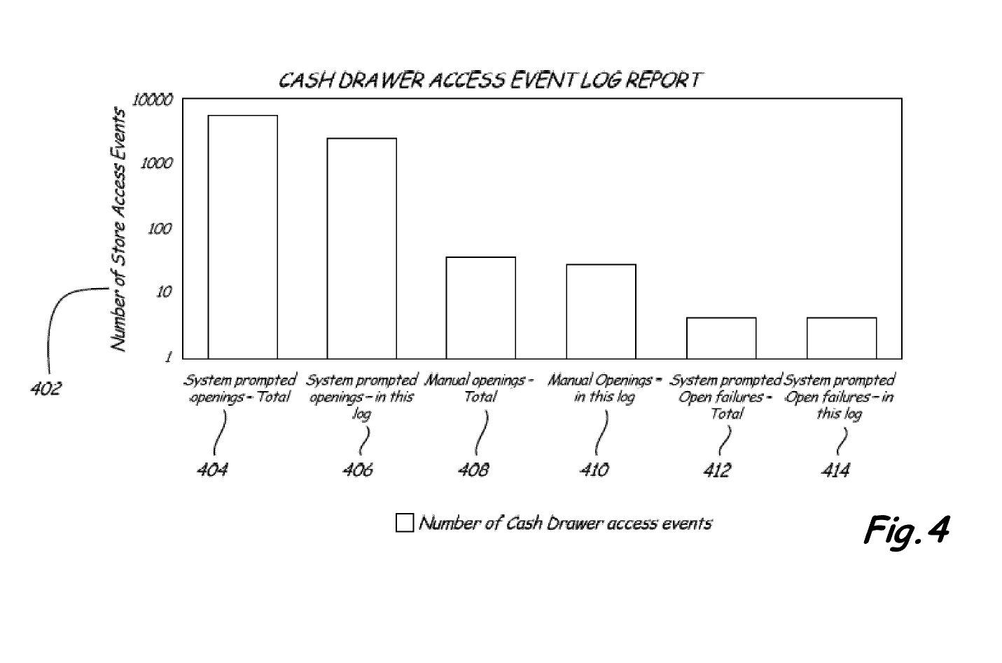

In an embodiment, one or more devices (e.g. a POS terminal 102 and/or remote help desk 112 in FIG. 1) connected to a cash drawer 104 are able to retrieve and process event logs from cash drawers. For instance, a device may be able to perform and display statistics of a cash drawer. FIG. 4 shows one example of a user interface displaying statistics calculated for a cash drawer. In particular, FIG. 4 shows a “Cash Drawer Access Event Log Report.” The vertical or y-axis includes a number of access events 402, and the horizontal or x-axis includes a description of an event. In the particular example shown in FIG. 4, the events along the horizontal axis include a total number of system prompted openings 404, a number of system prompted openings in this log 406, a total number of manual openings 408, a number of manual openings in this log 410, a total number of open failures for system prompted openings 412, and a number of open failures for system prompted openings in this log 414.

As can be seen in FIG. 4, one or more event logs from a cash drawer 104 may be processed to determine statistics for the performance of the cash drawer, and the statistics can be displayed in a graphical representation on a user interface. In the particular example shown in FIG. 4, the statistics are shown in the form of a bar graph. Embodiments are not however limited to any particular format and statistics may be shown in other formats such as textual representations, line graphs, pie charts, etc. Additionally, statistics for multiple cash drawers may be processed and/or displayed simultaneously. This would enable for instance for the performance of different cash drawers on a network to be compared.

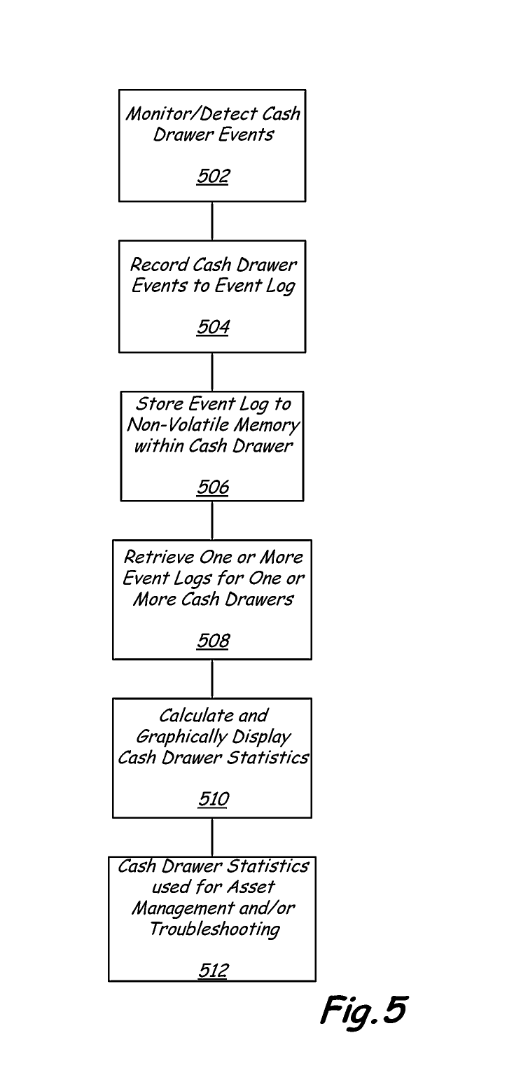

FIG. 5 shows an embodiment of one method according to the present disclosure. The method may be useful for example for troubleshooting cash drawer issues and/or for cash drawer asset management. At block 502, cash drawer events (e.g. an open command) are monitored or detected. At block 504, cash drawer events and any other related information (e.g. an event status) are stored to an event log. At block 506, the event log is saved to a non-volatile memory within a cash drawer. At block 508, one or more event logs for one or more cash drawers is retrieved. At block 510, the event log or logs are processed to calculate and display cash drawer statistics, and at block 512, cash drawer statistics are used for asset management and/or troubleshooting.

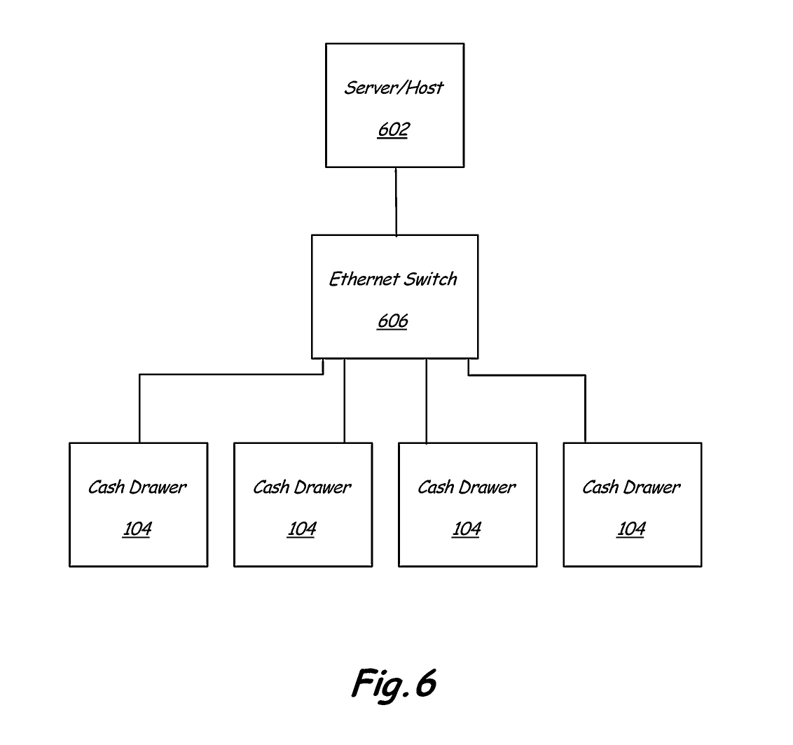

FIG. 6 shows one particular implementation of a cash drawer network. In the implementation shown in FIG. 6, a server/host 602 connects to four cash drawers 104 through an Ethernet switch 606. Server/host 602 illustratively includes POS software and is able to connect to, communicate with, and control each of the cash drawers 104. Switch 606 processes and routes data between the server/host 602 and the cash drawers 104. Embodiments of the present disclosure are not however limited to any particular implementation and may include for example more or less cash drawers, hosts/servers, and or other devices. For example, embodiments are not limited to any particular devices for establishing a network and may include one or more switches, hubs, relays, repeaters, or other hardware/software configurations to establish a network. The embodiment shown in FIG. 6 is merely provided to show one example of a configuration within the scope of the present disclosure.

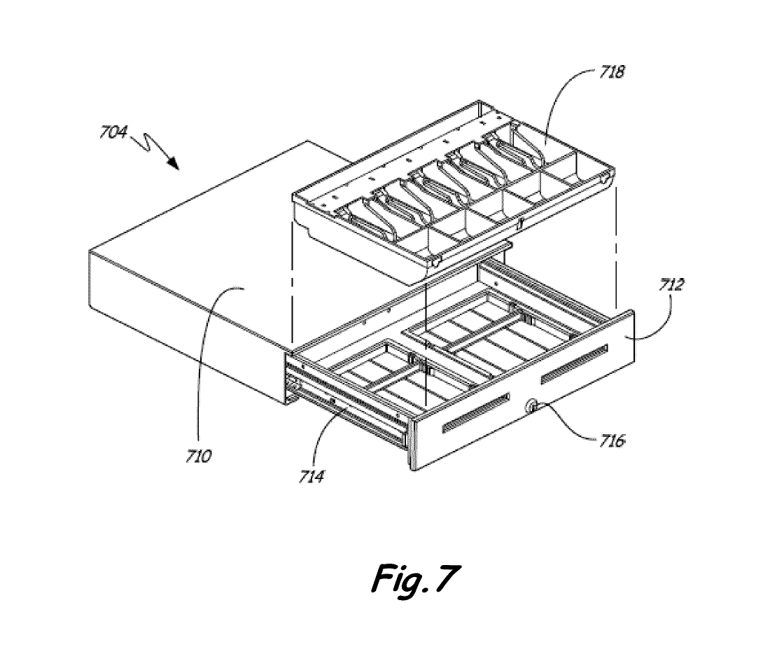

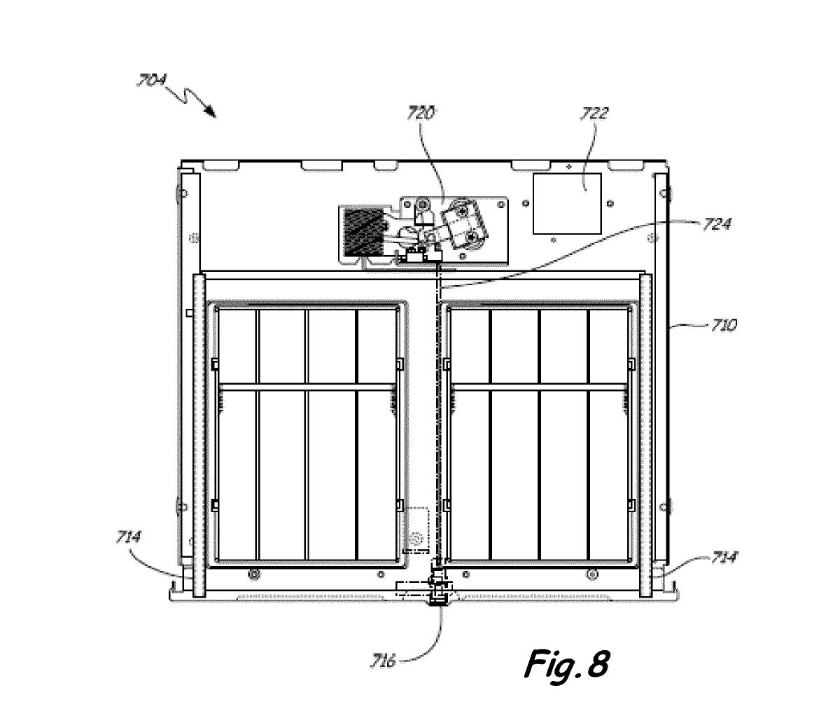

FIGS. 7 and 8 show an example of a cash drawer 704 that may be used in some embodiments. Embodiments of the present disclosure are not however limited to any particular type of cash drawer, and embodiments illustratively include cash drawers having any configuration. FIG. 7 is a perspective view of cash drawer 704. FIG. 7 shows that cash drawer 704 includes a drawer housing 710, a moveable drawer 712, a set of slides 714 that enable drawer 712 to move into and out of housing 710, a manual open/close mechanism 716 (e.g. a key lock), and a removable till 718 for holding currency, receipts, etc.

FIG. 8 shows a top down view of cash drawer 704 with the top of the housing 710 and the till 718 having been removed. FIG. 8 shows that cash drawer 704 also includes a latch bracket assembly 720 for opening/closing the moveable drawer 712 and an electrical circuit board 722 having one or more electrical components for operating the drawer. For example, electrical circuit board 722 may include one or more of the electrical components shown in FIG. 2. Other embodiments of cash drawers 704 may include multiple circuit boards 722 and/or circuit boards with different locations (e.g. beneath moveable drawer 712). FIG. 8 further shows that cash drawer 704 includes a lock rod 724 that connects the manual open/close mechanism 716 to the latch bracket assembly 720. Lock rod 724 is illustratively used to release the latch within latch bracket assembly 720 to move drawer 712 into an open position.

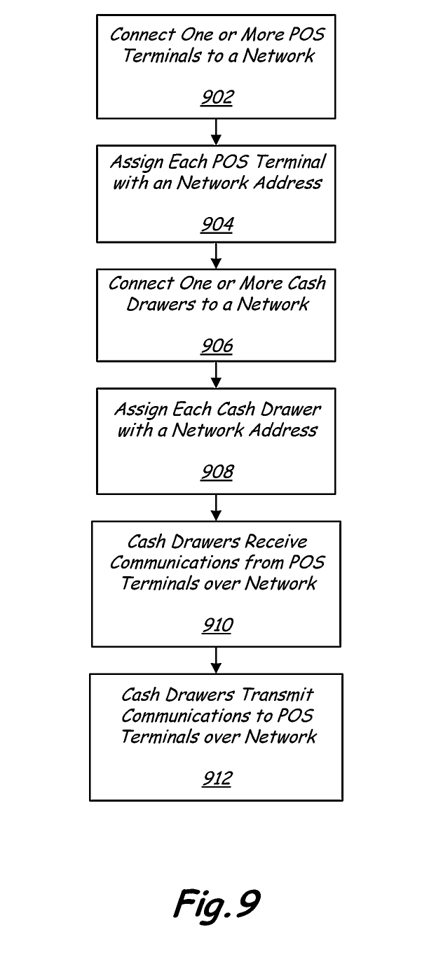

FIG. 9 shows an embodiment of a method of communicating with a cash drawer according to an embodiment of the present disclosure. At block 902, one or more POS terminals are connected to a network (e.g. an Ethernet network). The connections may be wireless (e.g. Wi-Fi or Bluetooth) or may be wired. At block 904, each POS terminal is addressed. Embodiments are not limited to any particular method of addressing. For instance, embodiments may receive a static or dynamic address. Embodiments may also receive a unique address such as an address based on their Media Access Control “MAC” identifier. At block 906, one or more cash drawers are connected to the network. The cash drawer connections may also be wireless or wired. At block 908, each cash drawer is addressed. Cash drawers may utilize any method of addressing such as the previously mentioned static and dynamic addressing, and may likewise receive a unique address such as, but not limited to, an address based on their MAC identifier. At block 910, cash drawers receive communications from POS terminals over the network, and at block 912, cash drawers transmit communications to POS terminals over the network. Embodiments are not limited to any particular methods of sending or receiving communications. However, in one embodiment, for illustration purposes only and not by limitation, communications are sent in the form of a data packet frame that includes a source device address, a destination device address, the data to be transmitted, and a cyclic redundancy check. Also, it should be mentioned that the data to be transmitted can include any data. For instance, a POS terminal can send a command such as a cash drawer open command, and a cash drawer can send data such as an event log.

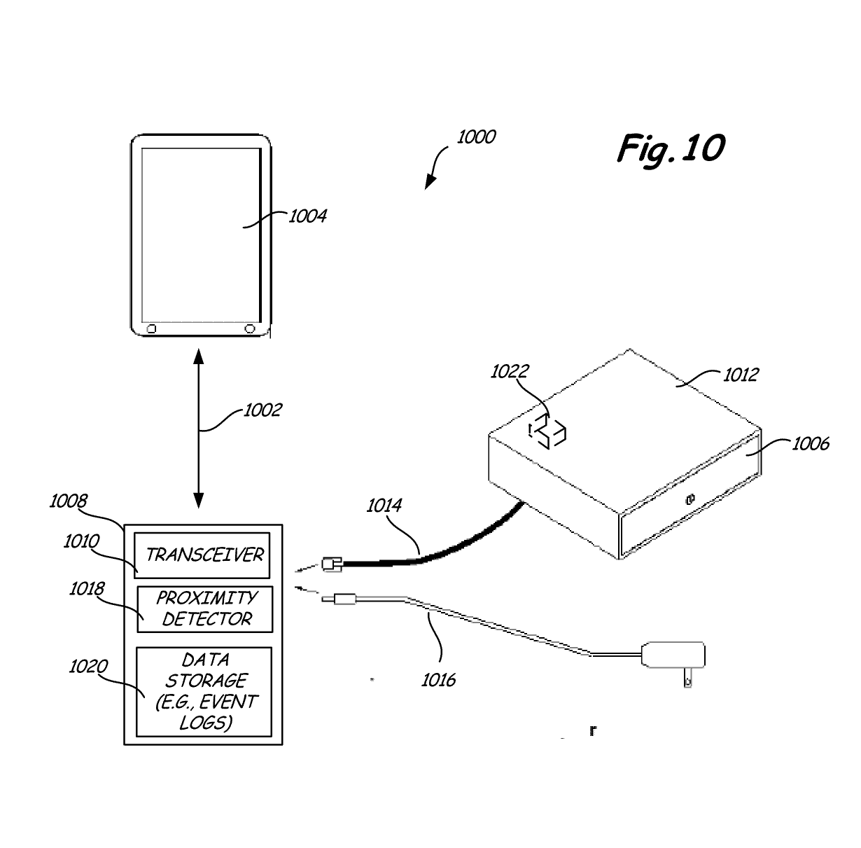

FIG. 10 is a diagram of an exemplary system 1000 having a wireless cash drawer communication interface 1002. Illustratively, a cash drawer 1006 can be communicatively connected to a client device 1004 without requiring the cash drawer 1006 to be connected through a router and/or a receipt printer.

Although other wireless protocols can be utilized, communication interface 1002 illustratively comprises a Bluetooth interface between a client device 1004 and a cash drawer 1006 in which client device 1004 is paired to cash drawer 1006, for example in a one-to-one relationship, such that only the paired device can open and control cash drawer 1006.

While FIG. 10 shows a single client device 1004 communicatively connected to a single cash drawer 1006, it is noted that any number of client devices and cash drawers may be utilized. For example, client device 1004 can be configured to communicate with and control a plurality of cash drawers, and/or cash drawer 1006 can be controlled by a plurality of client devices. In one embodiment, interface 1002 connects cash drawer 1006 in a wireless network to at least one client device. For example, data can be wirelessly transferred between device 1004 and drawer 1006 within a personal area network.

In one example, device 1006 comprises a POS terminal, such as terminal 102 discussed above. In the illustrated example, device 1006 comprises a thin-client mobile device, such as, but not limited to, a mobile phone or tablet. Device 1006 includes a user interface that enables a user to control cash drawers 1006, and can include some or all of the functionality described above with respect to POS terminal 102. In one example, a point of sale application running on a mobile operating system (e.g., iOS, Android OS) presents a user interface on device 1006 facilitating transactions in a retail environment.

Cash drawer 1006 uses a Bluetooth controller 1008 having a Bluetooth transceiver 1010 for sending and receiving information over interface 1002. In the illustrated embodiment, controller 1008 comprises a separate, external module that is connected to cash drawer 1006 through a line 1014 that transmits signals and/or data to control cash drawer 1006, such as but not limited to an open drawer command, a prompt to have the cash drawer return its open/closed status command, a retrieve and clear event logs command, an assign user specific information into a cash drawer asset event log command, a controlled user access command to set a real time clock for date and time stamping of events, and a cash drawer audible alerts enable/disable command that optionally enables or disables an audible alert.

In this manner, controller 1008 can be implemented with wired cash drawers, such as those designed to connect through a receipt printer, to provide wireless functionality. In one example, but not by limitation, line 1014 connects to controller 1008 using an RJ-11 connector. In another example, but not by limitation, line 1014 connects to controller 1008 using an RJ-45 connector.

It is noted that some or all components of controller 1008 can be incorporated within cash drawer 1006. For example, controller 108 can comprise circuitry disposed at a location generally represented by block 1022 within a housing 1012 of cash drawer 1006. In one particular example, the circuitry can be disposed in a manner similar to electrical circuit board 722 illustrated in FIG. 8.

Cash drawer 1006 includes an actuator (not shown in FIG. 10), such as actuator 210, and a device controller (not shown in FIG. 10). The device controller monitors the open/closed status of the movable drawer and provides an electrical pulse that energizes a solenoid to release a latch that allows the movable drawer to be opened. Also, the device controller can support auxiliary hardware that provides feedback of cash drawer operations or status such as, but not limited to, lights (e.g. LEDs) that report status and/or audible alerts that inform users or managers nearby if the cash drawer has been opened.

In the illustrated embodiment, controller 1008 is configured to provide power to cash drawer 1006 through line 1014 to support opening of cash drawer 1006. Controller 1008 can be powered, for example, by an internal power source such as one or more batteries, and/or by an external power source through a power adapter 1016.

In one embodiment, an initial pairing process (e.g., legacy pairing, secure simple pairing (SSP)) is required between device 1004 and cash drawer 1006 before device 1004 is enabled to control cash drawer 1006. This can provide a layer of security to guard against an unauthorized device gaining control to open cash drawer 1006. Alternatively, or in addition, controller 1008 can be configured to communicate drawer status (i.e., open or closed) to device 1004, which may alert a user if an unauthorized drawer opening occurs.

In one embodiment, controller 1008 has a memory component 1020 that includes any type or combination of memory that may be useful in operation of controller 1008. In an embodiment, memory component 1020 may include volatile and non-volatile memory. Information that should be retained despite a power loss is illustratively stored to non-volatile memory such as, but not limited to, a magnetic hard disk drive, flash memory, or battery backed DRAM. Some information that may be stored to non-volatile memory includes event log information and applications. For example, controller 1008 receives indications of cash drawer events from cash drawer 1006 over line 1014. The events can be stored in an event log in memory component 1020. One example of an event log is illustrated above with respect to FIG. 3.

Further, system 1000 can be configured to limit or prevent unattended openings of cash drawer 1006 (for example, an opening when a clerk is not present at cash drawer 1006). In one embodiment, transactional proximity is enforced by requiring that a paired client device 1004 be within a threshold distance (e.g., 3 feet, 5 feet, 10 feet) of the cash drawer 1006 before enabling access to cash drawer 1006. In the illustrated example, controller 1008 includes a proximity detection module 1018 that is configured to control access to cash drawer 1006 by client device 1004 (for example to open cash drawer 1006) based on a physical distance of the client device 1004 to cash drawer 1006. This can be performed, for example, by using a script that periodically checks (e.g., every 1 second, every 2 seconds, every 10 seconds, etc.) the distance between transceiver 1010 and client device 1004 based on a received signal strength indicator (RSSI).

As has been discussed above, at least some embodiments of the present disclosure include cash drawers having interfaces that enable the cash drawers to be connected to a network (e.g. an Ethernet network). In one embodiment, each cash drawer acts as a node on the network as a free-standing network device. The cash drawers are not simply devices that are physical peripherals to a host PC. In at least certain embodiments, cash drawers generate and store event logs that may be useful for tasks such as device troubleshooting and/or asset management. Additionally, one or more event logs may be processed to generate cash drawer statistics which may be graphically displayed to a user. Accordingly, embodiments of cash drawers of the present disclosure may be advantageous in at least certain situations over other cash drawers which may not be connectable to a network and/or may not have event logs.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to cash drawers, it will be appreciated by those skilled in the art that the teachings of the disclosure can be applied to other types of systems, without departing from the scope and spirit of the disclosure.

What is claimed is:

1. A cash drawer comprising:
a processing unit that detects a cash drawer event; and
a Bluetooth interface configured to transmit an indication of the cash drawer event.

2. The cash drawer of claim 1, further comprising:
a storage component that stores the indication of the cash drawer event.

3. The cash drawer of claim 1, wherein cash drawer events are stored as entries in an event log.

4. The method of claim 3, wherein each entry in the event log includes at least one of:
an event identifier
an event status; and
time and date identifiers.

5. The method of claim 1, and comprising:
a cash drawer housing; and
a moveable drawer that fits within the housing;
wherein the Bluetooth interface is disposed within the housing.

6. The cash drawer of claim 1, wherein the cash drawer receives electrical power from an external supply.

7. The cash drawer of claim 1, wherein the cash drawer event comprises an opening of the cash drawer.

8. A cash drawer comprising:
a cash drawer housing;
a moveable drawer that fits within the housing; and
a Bluetooth receiver that receives a command to control the cash drawer over a wireless connection using Bluetooth.

9. The cash drawer of claim 8, wherein the Bluetooth receiver is disposed within the cash drawer housing.

10. The cash drawer of claim 8, further comprising:
a device controller that opens the moveable drawer based on the command.

11. The cash drawer of claim 8, further comprising:
a memory component that stores an event log.

12. The cash drawer of claim 11, wherein the memory component comprises non-volatile memory.

13. The cash drawer of claim 8, wherein the cash drawer receives power from an external supply.

14. An apparatus comprising:
a Bluetooth receiver configured to receive a cash drawer command from a client device; and
an interface configured to provide the cash drawer command to a cash drawer device controller.

15. The apparatus of claim 14, wherein the interface is configured to communicate with the cash drawer device controller through a wired connection.

16. The apparatus of claim 15, wherein the apparatus is disposed within a cash drawer housing.

17. The apparatus of claim 16, wherein the cash drawer housing has an opening that receives a movable drawer.

18. The apparatus of claim 14, wherein the client device comprises a point of sale (POS) terminal.

19. The apparatus of claim 14, wherein the client device comprises a mobile device.

20. The apparatus of claim 14, wherein the client device comprises a tablet computer.
